(19) United States
(12) Patent Application Publication
(10) Pub. No.: US 2026/0142423 A1
(43) Pub. Date: May 21, 2026

(54) ELECTRICAL CONNECTOR WITH IMPROVED SHIELDING EFFECT

(71) Applicant: DONGGUAN LUXSHARE TECHNOLOGIES CO., LTD, Dongguan City, Guangdong Province (CN)

(72) Inventors: Kunlin YAO, Dongguan City (CN); Tengfang Xiong, Dongguan City (CN); Huanhuan SHEN, Dongguan City (CN)

(73) Assignee: DONGGUAN LUXSHARE TECHNOLOGIES CO., LTD, Dongguan City, Guangdong Province (CN)

(21) Appl. No.: 19/034,339

(22) Filed: Jan. 22, 2025

(30) Foreign Application Priority Data
Nov. 21, 2024 (CN) 202411678942.5

(51) Int. Cl. H01R 13/6581; H01R 12/72; H01R 12/73; H01R 13/05; H01R 13/639; H01R 13/652

(52) U.S. Cl. CPC H01R 13/6581; H01R 12/721; H01R 12/73; H01R 13/05; H01R 13/639; H01R 13/652

(57) ABSTRACT

An electrical connector includes a mounting housing and a first terminal module. The first terminal module includes a first signal terminal, a second signal terminal, a first ground terminal and a second ground terminal. Each first conductive terminal includes a first contact elastic arm having a first arc-shaped end portion. A dimension of the first arc-shaped end portion of the first ground terminal is larger than a dimension of the first arc-shaped end portion of the first signal terminal, and is also larger than a dimension of the first arc-shaped end portion of the second signal terminal. A dimension of the first arc-shaped end portion of the second ground terminal is larger than the dimension of the first arc-shaped end portion of the first signal terminal, and is also larger than the dimension of the first arc-shaped end portion of the second signal terminal.

### CROSS-REFERENCE TO RELATED APPLICATION

This patent application claims priority of a Chinese Patent Application No. 202411678942.5, filed on Nov. 21, 2024 and titled “ELECTRICAL CONNECTOR”, the entire content of which is incorporated herein by reference.

### TECHNICAL FIELD

The present disclosure relates to an electrical connector, which belongs to the technical field of electrical connectors.

### BACKGROUND

Electrical connectors in the related art generally include a mounting housing and a plurality of terminal modules mounted to the mounting housing. The terminal module includes a plurality of conductive terminals. The plurality of conductive terminals include a first signal terminal, a second signal terminal, a first ground terminal disposed on one side of the first signal terminal and the second signal terminal, and a second ground terminal disposed on another side of the first signal terminal and the second signal terminal. Each conductive terminal includes a contact elastic arm. The contact elastic arm is provided with an arc-shaped end portion. The arc-shaped end portion includes a contact portion that protrudes into a receiving slot of the mounting housing and is configured to be in contact with a mating module.

However, how to optimize the design of the contact portions of the conductive terminals to improve the quality of signal transmission is a technical problem to be solved by those skilled in the art.

### SUMMARY

An object of the present disclosure is to provide an electrical connector with improved shielding effect at first contact portions of first conductive terminals.

In order to achieve the above object, the present disclosure adopts the following technical solution: an electrical connector, including: a mounting housing, the mounting housing defining a receiving slot extending along a first direction, the receiving slot being configured to receive a mating module; and a first terminal module, the first terminal module being directly or indirectly mounted to the mounting housing; the first terminal module including a plurality of first conductive terminals; the plurality of first conductive terminals including a first signal terminal, a second signal terminal, a first ground terminal disposed on one side of the first signal terminal and the second signal terminal, and a second ground terminal disposed on another side of the first signal terminal and the second signal terminal; the first ground terminal, the first signal terminal, the second signal terminal and the second ground terminal being disposed in sequence along a second direction; each first conductive terminal including a first contact elastic arm; the first contact elastic arm being provided with a first arc-shaped end portion; the first arc-shaped end portion including a first contact portion that protrudes into the receiving slot and is configured to contact the mating module; wherein a dimension of the first arc-shaped end portion of the first ground terminal along a third direction is larger than a dimension of the first arc-shaped end portion of the first signal terminal along the third direction; the dimension of the first arc-shaped end portion of the first ground terminal along the third direction is larger than a dimension of the first arc-shaped end portion of the second signal terminal along the third direction; a dimension of the first arc-shaped end portion of the second ground terminal along the third direction is larger than the dimension of the first arc-shaped end portion of the first signal terminal along the third direction; the dimension of the first arc-shaped end portion of the second ground terminal along the third direction is larger than the dimension of the first arc-shaped end portion of the second signal terminal along the third direction; each two of the first direction, the second direction and the third direction are perpendicular to each other.

In order to achieve the above object, the present disclosure adopts the following technical solution: an electrical connector, including: a mounting housing defining a receiving slot extending along a first direction; the receiving slot being configured to receive a mating module; and a first terminal module including a plurality of first conductive terminals; the plurality of first conductive terminals including a first signal terminal, a second signal terminal, a first ground terminal and a second ground terminal; the first signal terminal and the second signal terminal together forming a first differential pair; the first ground terminal, the first signal terminal, the second signal terminal and the second ground terminal being disposed in sequence along a second direction; each first conductive terminal including a first contact elastic arm; the first contact elastic arm being provided with a first arc-shaped end portion; the first arc-shaped end portion including a first contact portion that protrudes into the receiving slot and is configured to electrically contact the mating module; wherein a dimension of the first arc-shaped end portion of the first ground terminal along a third direction is larger than a dimension of the first arc-shaped end portion of the first signal terminal along the third direction; the dimension of the first arc-shaped end portion of the first ground terminal along the third direction is larger than a dimension of the first arc-shaped end portion of the second signal terminal along the third direction; a dimension of the first arc-shaped end portion of the second ground terminal along the third direction is larger than the dimension of the first arc-shaped end portion of the first signal terminal along the third direction; the dimension of the first arc-shaped end portion of the second ground terminal along the third direction is larger than the dimension of the first arc-shaped end portion of the second signal terminal along the third direction; each two of the first direction, the second direction and the third direction are perpendicular to each other.

Compared with the prior art, in the electrical connector of the present disclosure, the dimension of the first arc-shaped end portion of the first ground terminal along the third direction is larger than the dimension of the first arc-shaped end portion of the first signal terminal along the third direction. The dimension of the first arc-shaped end portion of the first ground terminal along the third direction is larger than the dimension of the first arc-shaped end portion of the second signal terminal along the third direction. The dimension of the first arc-shaped end portion of the second ground terminal along the third direction is larger than the dimension of the first arc-shaped end portion of the first signal terminal along the third direction. The dimension of the first arc-shaped end portion of the second ground terminal along the third direction is larger than the dimension of the first arc-shaped end portion of the second signal terminal along the third direction. With this arrangement, the relatively high-height first arc-shaped end portion of the first ground terminal and the relatively high-height first arc-shaped end portion of the second ground terminal are provided on two sides of the first arc-shaped end portion of the first signal terminal and the first arc-shaped end portion of the second signal terminal, respectively, which is beneficial to improving the quality of signal transmission.

### BRIEF DESCRIPTION OF DRAWINGS

FIG. 1 is a perspective schematic view of a connector assembly in accordance with an embodiment of the present disclosure;

FIG. 2 is a partially exploded perspective view of FIG. 1;

FIG. 3 is a partially exploded perspective view of FIG. 2 from another angle;

FIG. 4 is a partially exploded perspective view of an electrical connector in accordance with an embodiment of the present disclosure, in which a mounting housing is separated;

FIG. 5 is a partially exploded perspective view of FIG. 4 from another angle;

FIG. 6 is a partial enlarged view of circled portion B in FIG. 5;

FIG. 7 is a partially exploded perspective view of a first terminal module and a second terminal module in FIG. 4;

FIG. 8 is a partially exploded perspective view of FIG. 7 from another angle;

FIG. 9 is a right view of FIG. 7;

FIG. 10 is a rear view of FIG. 7;

FIG. 11 is a partially exploded perspective view of the first terminal module in FIG. 7;

FIG. 12 is a partially exploded perspective view of FIG. 11 from another angle;

FIG. 13 is a partially exploded perspective view of the second terminal module in FIG. 7;

FIG. 14 is a partially exploded perspective view of FIG. 13 from another angle;

FIG. 15 is a partial perspective view of FIG. 7 after removing a first insulating block and a second insulating block;

FIG. 16 is a partial perspective view of FIG. 15 from another angle;

FIG. 17 is a further exploded perspective view of FIG. 11;

FIG. 18 is an exploded perspective view of FIG. 17 from another angle;

FIG. 19 is a further exploded perspective view of FIG. 13;

FIG. 20 is an exploded perspective view of FIG. 19 from another angle;

FIG. 21 is a perspective view of a first conductive terminal module in FIG. 17;

FIG. 22 is an exploded perspective view of FIG. 21;

FIG. 23 is a perspective view of a second conductive terminal module in FIG. 17;

FIG. 24 is an exploded perspective view of FIG. 23;

FIG. 25 is a perspective view of a third conductive terminal module in FIG. 19;

FIG. 26 is a perspective view of a fourth conductive terminal module in FIG. 19;

FIG. 27 is a top view of FIG. 21;

FIG. 28 is a perspective view of a first ground terminal, a first signal terminal, a second signal terminal and a second ground terminal in FIG. 17;

FIG. 29 is a partial enlarged view of circled portion C in FIG. 28;

FIG. 30 is a right view of the second signal terminal, the first signal terminal and the first ground terminal of the circled portion in FIG. 29;

FIG. 31 is a left side view of the first signal terminal, the second signal terminal and the second ground terminal of the circled portion in FIG. 29;

FIG. 32 is a right view of the first ground terminal, the first signal terminal, the second signal terminal and the second ground terminal in the circled portion of FIG. 29 when they are separated from one another; and

FIG. 33 is a schematic cross-sectional view taken along line D-D in FIG. 1, in which a mating module has not yet been inserted into the electrical connector.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

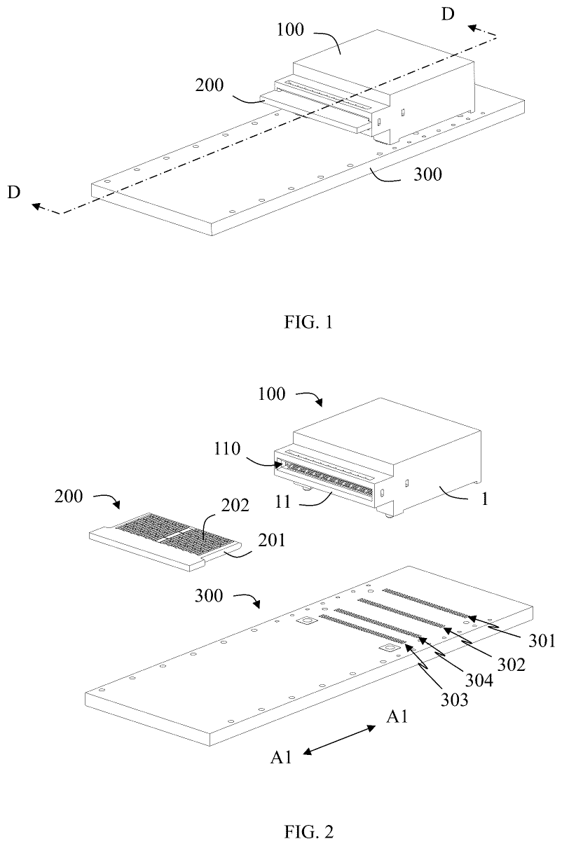

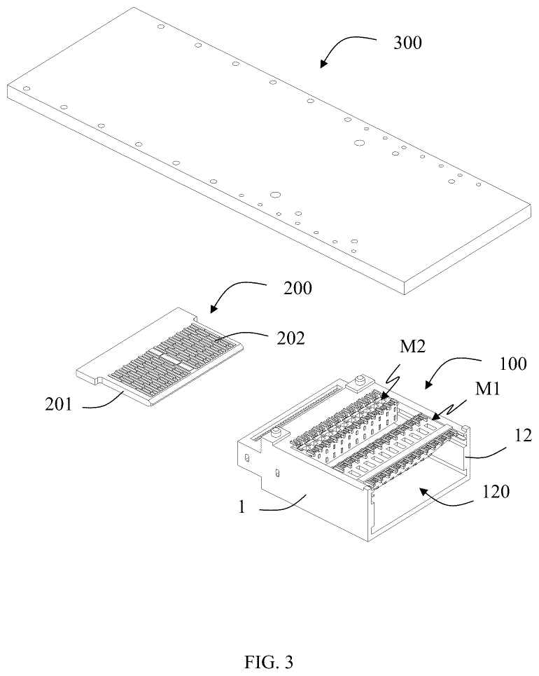

Referring to FIG. 1 to FIG. 3, the present disclosure discloses a connector assembly, which includes a circuit board 300, an electrical connector 100 installed on the circuit board 300, and a mating module 200 configured to be at least partially inserted into the electrical connector 100.

As shown in FIG. 2, in the illustrated embodiment of the present disclosure, the circuit board 300 includes a plurality of conductive pads exposed on a surface thereof. The conductive pads include a plurality of first conductive pads 301 arranged in a first row, a plurality of second conductive pads 302 arranged in a second row, a plurality of third conductive pads 303 arranged in a third row, and a plurality of fourth conductive pads 304 arranged in a fourth row. In the illustrated embodiment of the present disclosure, the first conductive pads 301, the second conductive pads 302, the third conductive pads 303 and the fourth conductive pads 304 are spaced apart along a first direction A1-A1 (for example, a front-rear direction) spaced arrangement.

The mating module 200 includes a tongue plate 201 which is provided with a plurality of conductive contact pads 202. In the illustrated embodiment of the present disclosure, the conductive contact pads 202 are exposed to two opposite surfaces of the tongue plate 201.

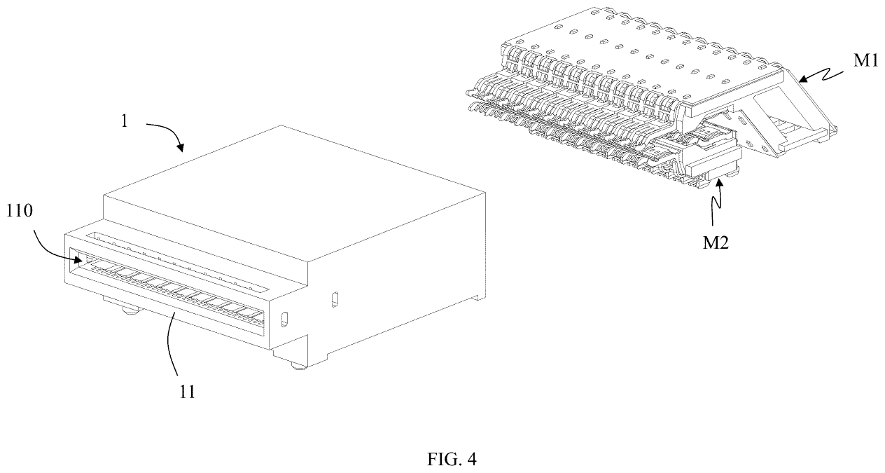

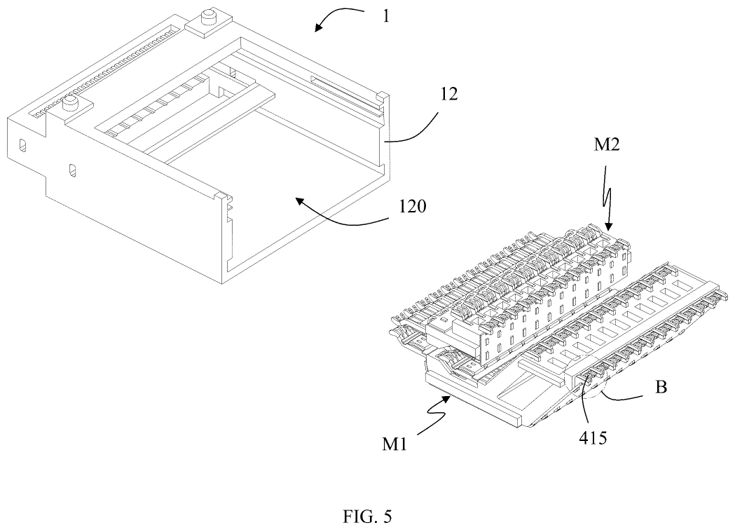

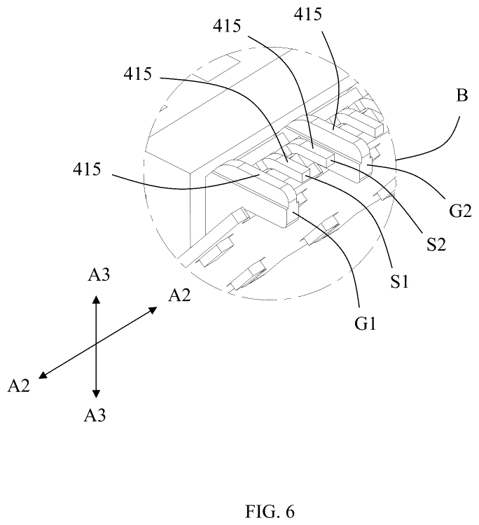

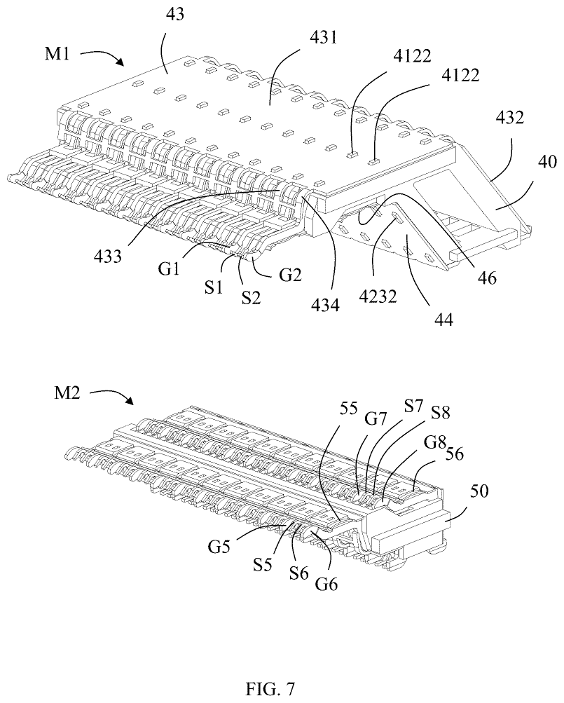

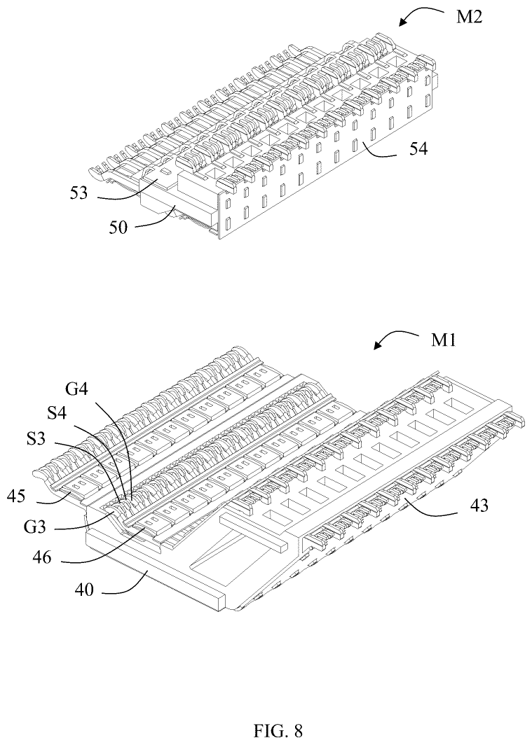

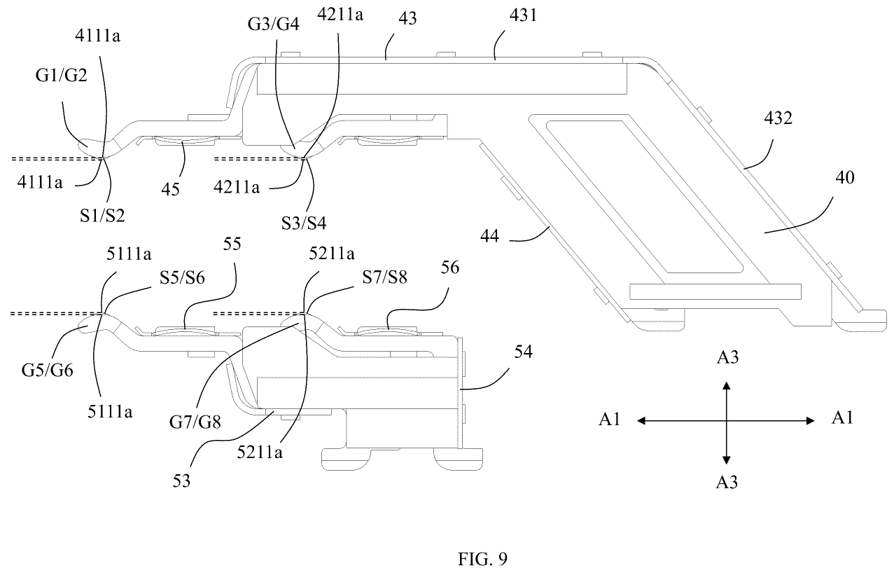

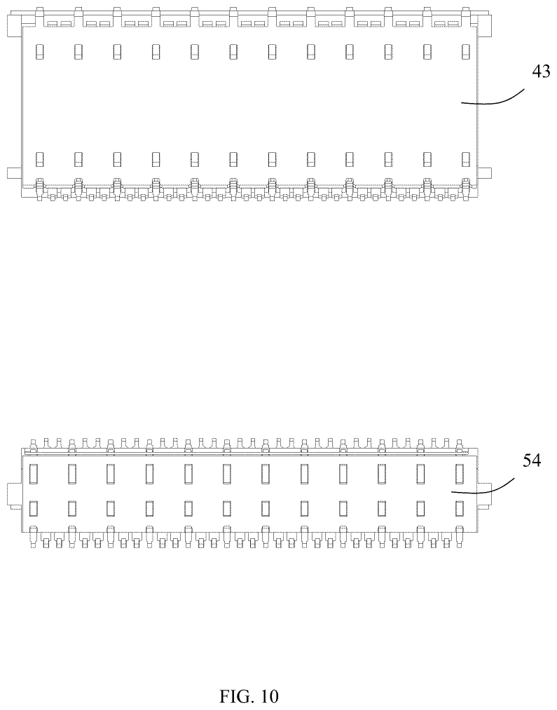

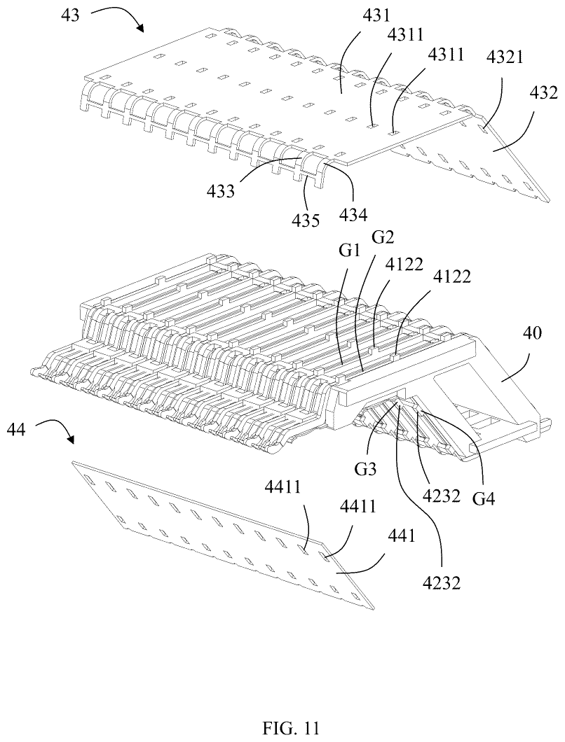

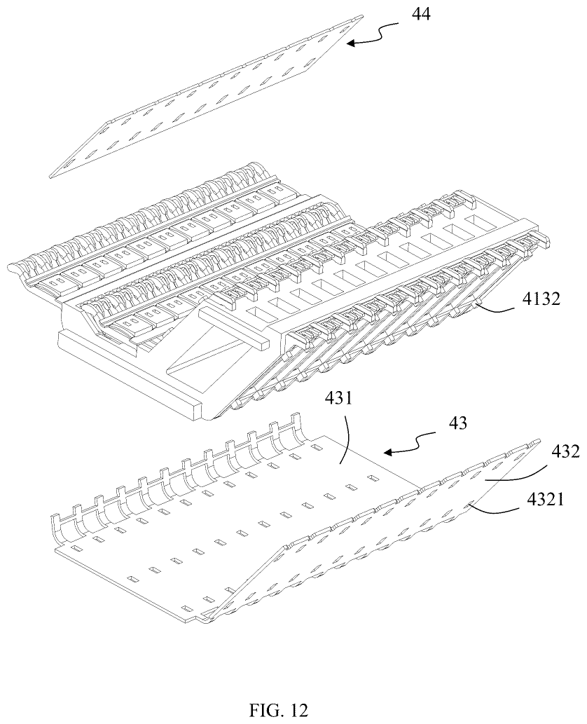

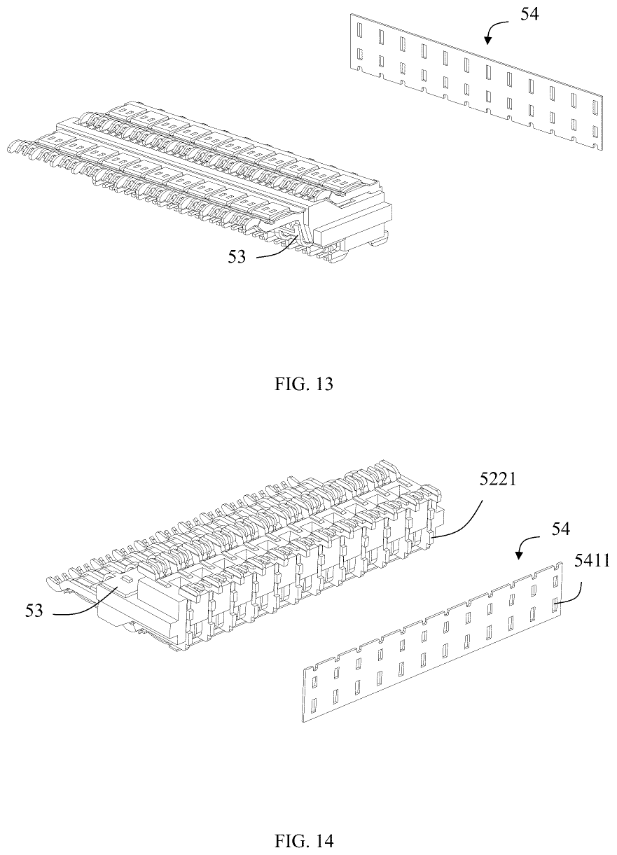

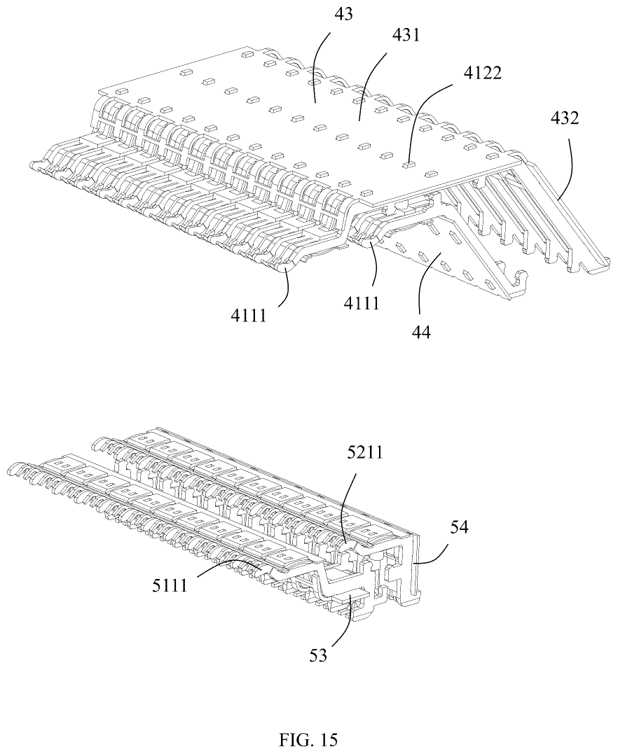

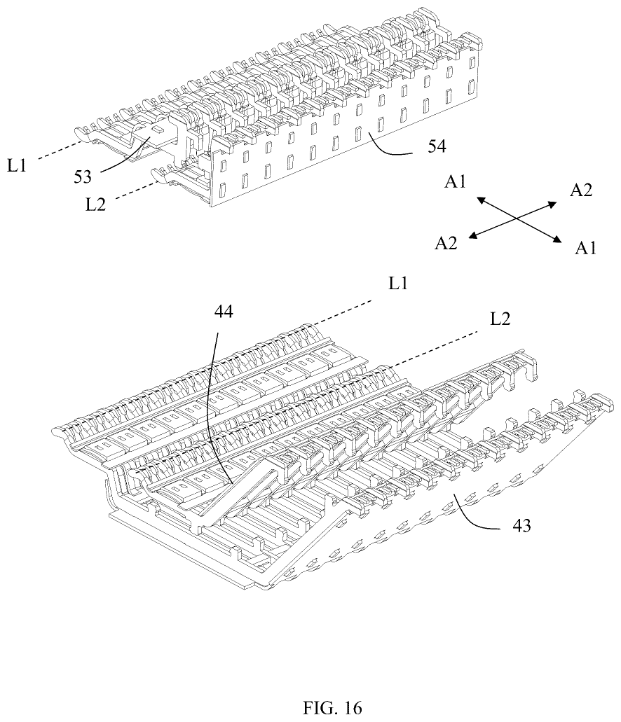

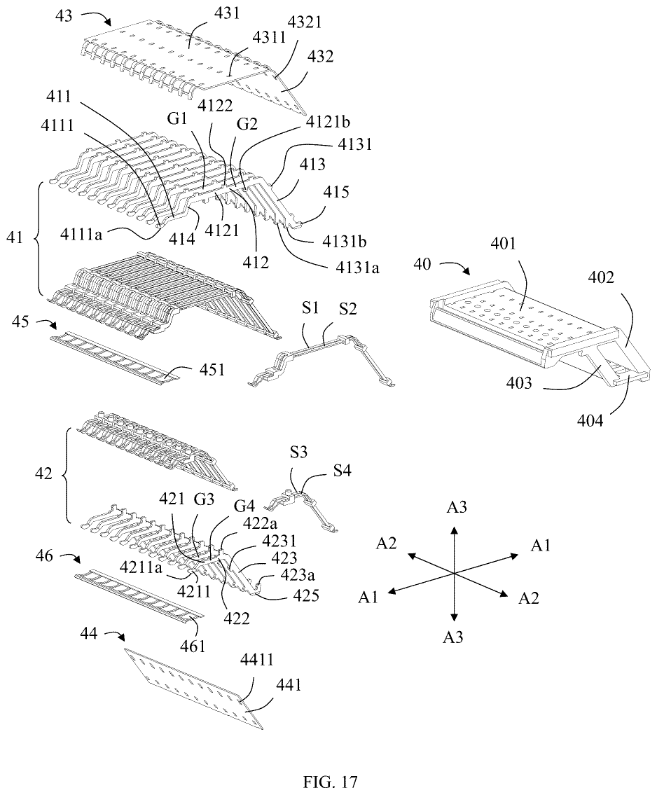

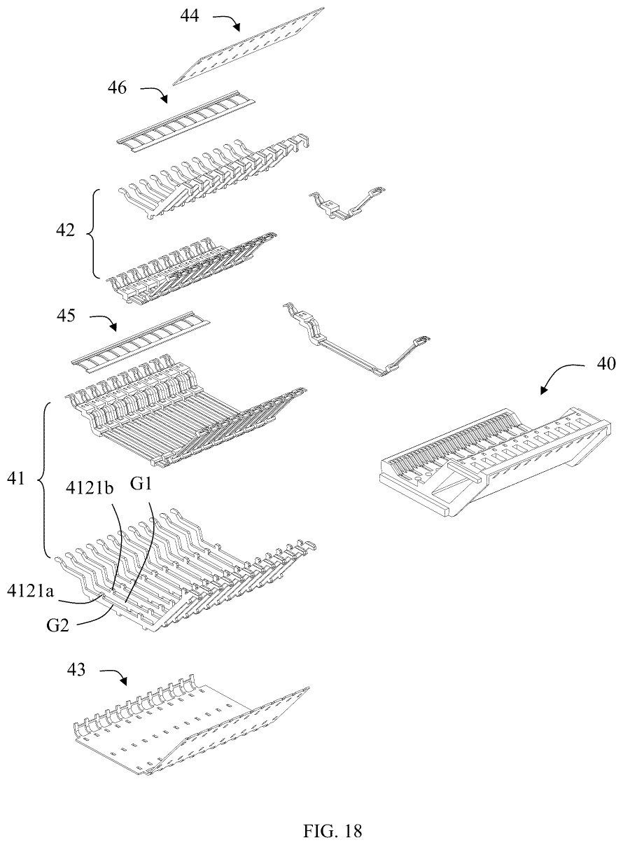

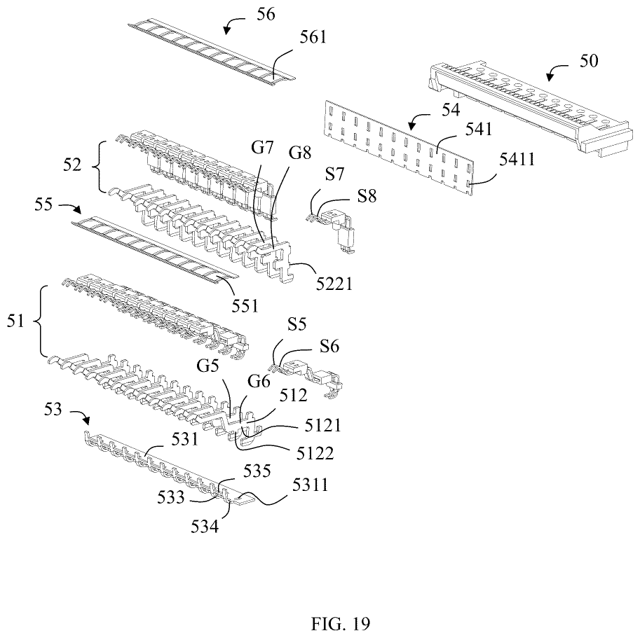

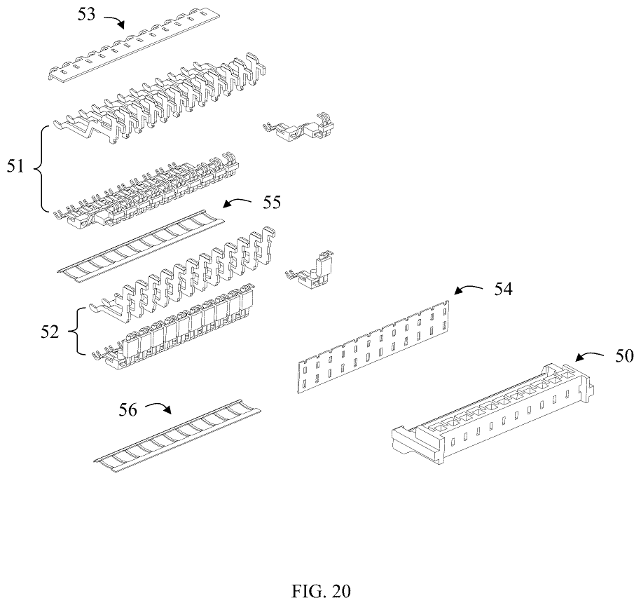

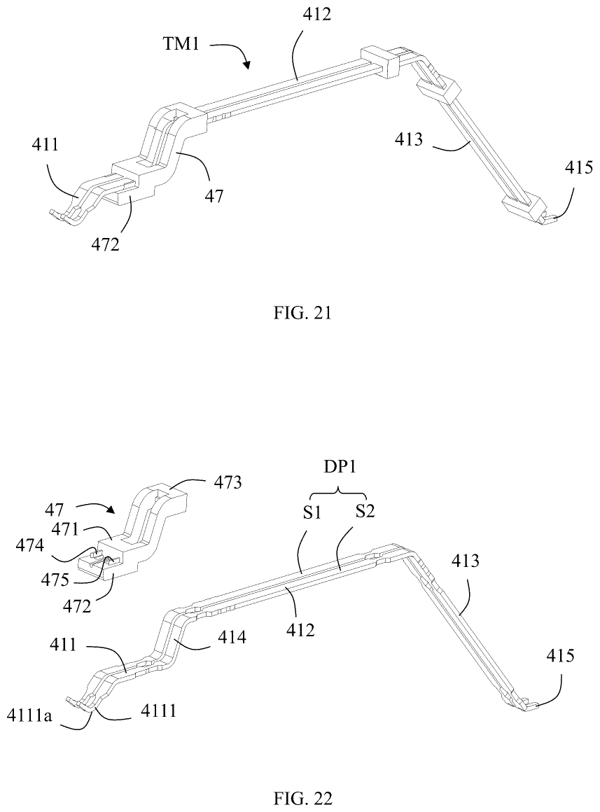

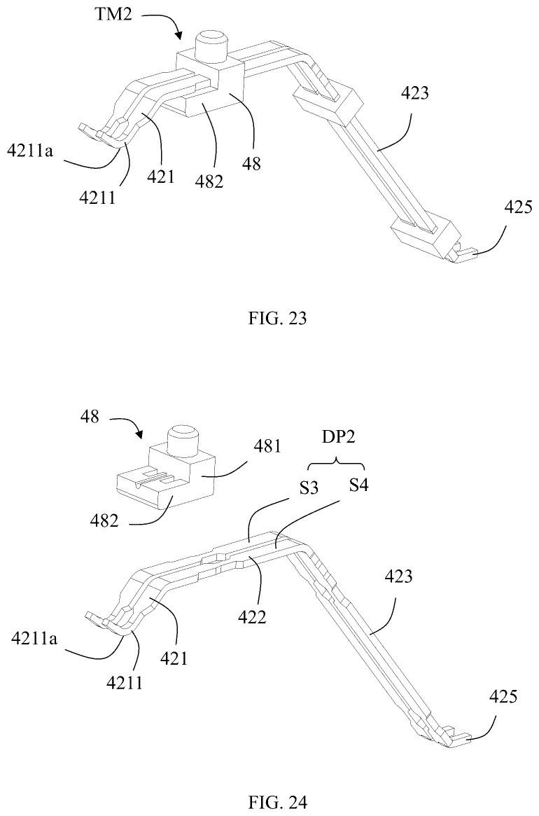

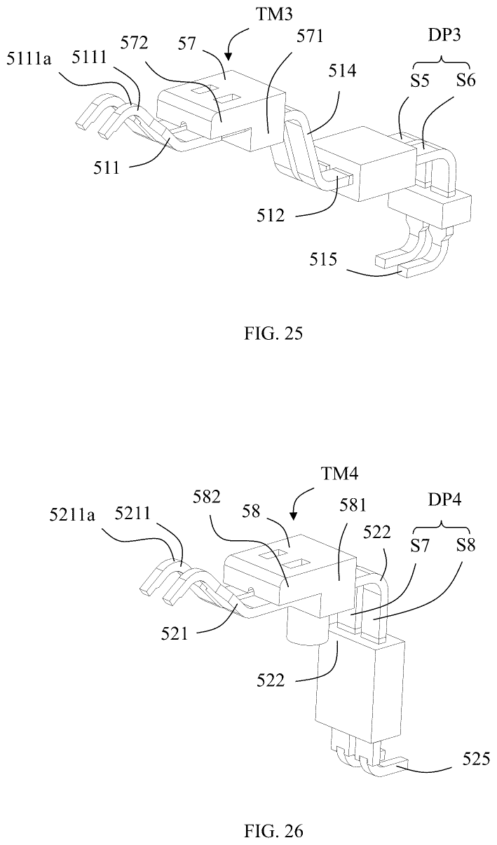

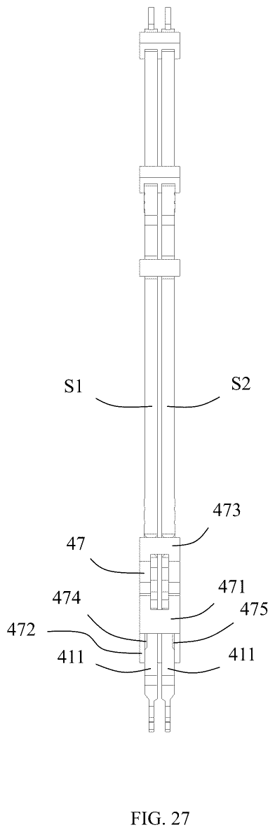

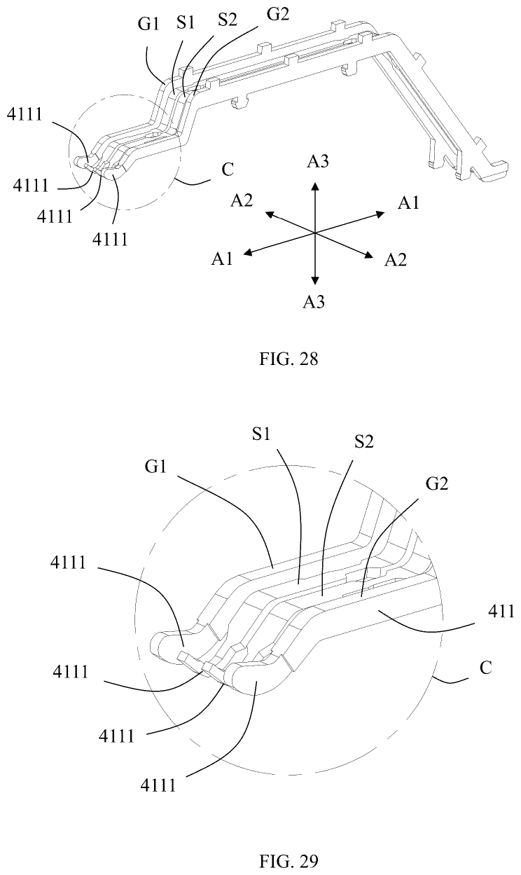

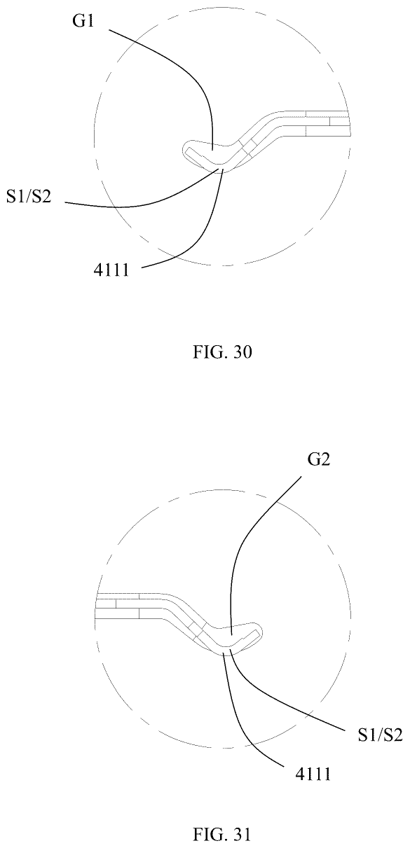

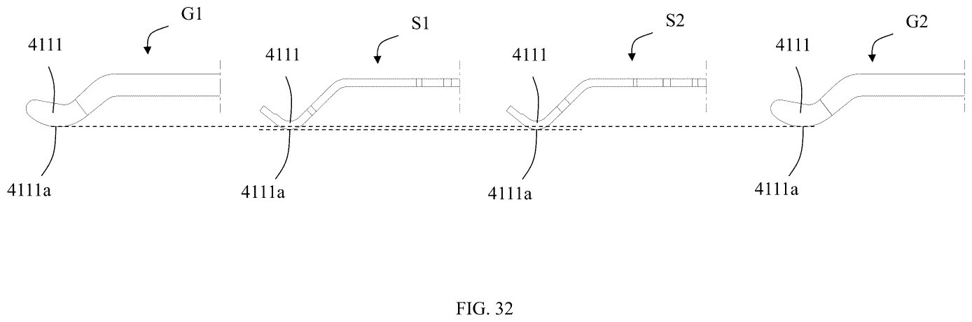

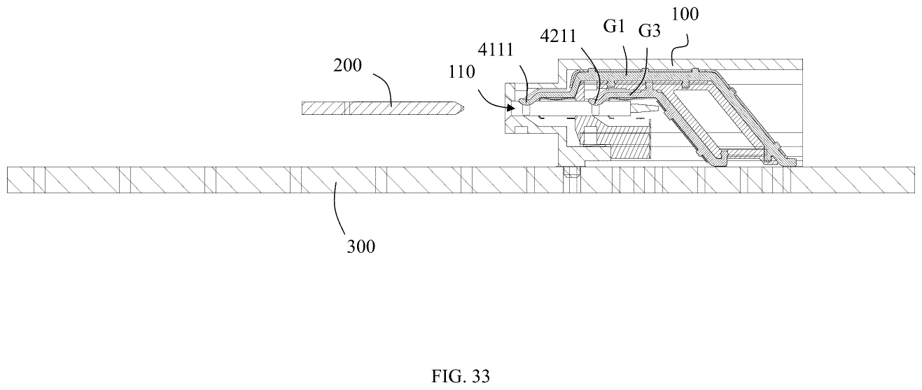

Referring to FIG. 2 to FIG. 33, in the illustrated embodiment of the present disclosure, the electrical connector 100 includes a mounting housing 1, a first terminal module M1 mounted directly or indirectly to the mounting housing 1, and a second terminal module M2 mounted directly or indirectly to the mounting housing 1. In the illustrated embodiment of the present disclosure, the first terminal module M1 and the second terminal module M2 are both directly mounted to the mounting housing 1.

In an embodiment of the present disclosure, the mounting housing 1 is made of insulating material. The mounting housing 1 includes a mating surface 11, a receiving slot 110 extending through the mating surface 11 along the first direction A1-A1, an installation surface 12 disposed opposite to the mating surface 11, and an installation space 120 extending through the installation surface 12 along the first direction A1-A1. The receiving slot 110 is configured to at least partially receive the mating module 200.

In the illustrated embodiment of the present disclosure, the first terminal module M1 includes a first insulating block 40, a plurality of first conductive terminals 41, a plurality of second conductive terminals 42, a first shielding plate 43, a second shielding plate 44, a first ground piece 45 and a second ground piece 46.

The first insulating block 40 includes a first body portion 401, a first inclined wall 402 extending obliquely from the first body portion 401, a second inclined wall 403 extending obliquely from the first body portion 401 and parallel to the first inclined wall 402, and a reinforcing wall 404 connecting the first inclined wall 402 and the second inclined wall 403.

The plurality of first conductive terminals 41 include a first signal terminal S1, a second signal terminal S2, a first ground terminal G1 disposed on one side of the first signal terminal S1 and the second signal terminal S2, and a second ground terminal G2 disposed on another side of the first signal terminal S1 and the second signal terminal S2. The first ground terminal G1, the first signal terminal S1, the second signal terminal S2 and the second ground terminal G2 are disposed in sequence along a second direction A2-A2 (for example, a left-right direction). In an embodiment of the present disclosure, the first signal terminal S1 and the second signal terminal S2 form a first differential pair DP1 in order to increase the signal transmission rate.

Each first conductive terminal 41 includes a first contact elastic arm 411, a first connecting portion 412, a first inclined portion 413 connected to the first connecting portion 412, a second inclined portion 414 connected between the first contact elastic arm 411 and the first connecting portion 412, and a first tail portion 415 extending from the first inclined portion 413. The first contact elastic arm 411 is provided with a first arc-shaped end portion 4111. The first arc-shaped end portion 4111 includes a first contact portion 4111a that protrudes into the receiving slot 110 and is configured to contact the mating module 200 for achieving electrical connection.

In the illustrated embodiment of the present disclosure, a dimension of the first arc-shaped end portion 4111 of the first ground terminal G1 along a third direction A3-A3 (for example, a top-bottom direction) is larger than a dimension of the first arc-shaped end portion 4111 of the first signal terminal S1 along the third direction A3-A3. The dimension of the first arc-shaped end portion 4111 of the first ground terminal G1 along the third direction A3-A3 is larger than a dimension of the first arc-shaped end portion 4111 of the second signal terminal S2 along the third direction A3-A3. A dimension of the first arc-shaped end portion 4111 of the second ground terminal G2 along the third direction A3-A3 is larger than the dimension of the first arc-shaped end portion 4111 of the first signal terminal S1 along the third direction A3-A3. The dimension of the first arc-shaped end portion 4111 of the second ground terminal G2 along the third direction A3-A3 is larger than the dimension of the first arc-shaped end portion 4111 of the second signal terminal S2 along the third direction A3-A3. With this arrangement, the first arc-shaped end portion 4111 of the first signal terminal S1 and the first arc-shaped end portion 4111 of the second signal terminal S2 are provided with a relatively high-height on two sides, respectively. The first arc-shaped end portion 4111 of the ground terminal G1 and the first arc-shaped end portion 4111 of the second ground terminal G2 are beneficial to improving the quality of signal transmission. In the illustrated embodiment of the present disclosure, each two of the first direction A1-A1, the second direction A2-A2, and the third direction A3-A3 are perpendicular to each other.

In the illustrated embodiment of the present disclosure, a dimension of the first contact elastic arm 411 of the first ground terminal G1 along the third direction A3-A3 is larger than a dimension of the first contact elastic arm 411 of the first signal terminal S1 along the third direction A3-A3. The dimension of the first contact elastic arm 411 of the first ground terminal G1 along the third direction A3-A3 is larger than a dimension of the first contact elastic arm 411 of the second signal terminal S2 along the third direction A3-A3. A dimension of the first contact elastic arm 411 of the second ground terminal G2 along the third direction A3-A3 is larger than the dimension of the first contact elastic arm 411 of the first signal terminal S1 along the third direction A3-A3. The dimension of the first contact elastic arm 411 of the second ground terminal G2 along the third direction A3-A3 is larger than the dimension of the first contact elastic arm 411 of the second signal terminal S2 along the third direction A3-A3. With this arrangement, the relatively high-height of the first contact elastic arm 411 of the first ground terminal G1 and the relatively high-height of the first contact elastic arm 411 of the second ground terminal G2 are provided on two sides of the first contact elastic arm 411 of the first signal terminal S1 and the first contact elastic arm 411 of the second signal terminal S2 in the length direction, which is beneficial to further improving the quality of signal transmission.

In the illustrated embodiment of the present disclosure, the first ground terminal G1 and the second ground terminal G2 are both made by blanking. It is understandable to those skilled in the art that the so-called “by blanking” means that a terminal width of the first ground terminal G1 and the second ground terminal G2 along the second direction A2-A2 is the same as a width of a material strip. In other words, if the terminal widths of the first ground terminal G1 and the second ground terminal G2 along the second direction A2-A2 need to be larger, correspondingly, a thicker material strip needs to be used.

The first signal terminal S1 and the second signal terminal S2 are both made by stamping. It is understandable to those skilled in the art that the so-called “by stamping” means that the first signal terminal S1 and the second signal terminal S2 are stamped from a metal plate. The widths of the first signal terminal S1 and the second signal terminal S2 can be stamped and formed on the metal plate as needed. The width of the first signal terminal S1 and the second signal terminal S2 is not affected by the thickness of the metal plate.

Of course, it is understandable to those skilled in the art that the first contact elastic arm 411 of the first ground terminal G1 and the first contact elastic arm 411 of the second ground terminal G2 which are made by blanking have greater rigidity compared to the first contact elastic arm 411 of the first signal terminal S1 and the first contact elastic arm 411 of the second signal terminal S2 which are made by stamping. In other words, the first contact elastic arms 411 of the first ground terminal G1 and the second ground terminal G2 made by blanking are not prone to elastic deformation compared to the first contact elastic arms 411 of the first signal terminal S1 and the second signal terminal S2 made by stamping.

In the illustrated embodiment of the present disclosure, the first contact portion 4111a of the first signal terminal S1 is flush with the first contact portion 4111a of the second signal terminal S2. The first contact portion 4111a of the first ground terminal G1 is flush with the first contact portion 4111a of the second ground terminal G2.

The first contact portion 4111a of the first signal terminal S1 and the first contact portion 4111a of the second signal terminal S2 protrude downwardly beyond the first contact portion 4111a of the first ground terminal G1 and the first contact portion 4111a of the second ground terminal G2 along the third direction A3-A3, so that the first contact portion 4111a of the first signal terminal S1 and the first contact portion 4111a of the second signal terminal S2 protrude into the receiving slot 110 further than the first contact portion 4111a of the first ground terminal G1 and the first contact portion 4111a of the second ground terminal G2. With this arrangement, by placing the first contact portion 4111a of the first ground terminal G1 and the first contact portion 4111a of the second ground terminal G2 that are less likely to elastically deform, further away from the receiving slot 110, it is possible to form a balance between the first ground terminal G1 and the second ground terminal G2 made by blanking and the first signal terminal S1 and the second signal terminal S2 made by stamping.

In the illustrated embodiment of the present disclosure, the first terminal module M1 further includes a first retaining block 47 fixed on the first signal terminal S1 and the second signal terminal S2, so that the first signal terminal S1, the second signal terminal S2 and the first retaining block 47 form an integrated first terminal module TM1. In one embodiment of the present disclosure, the first contact elastic arm 411 of the first signal terminal S1 and the first contact elastic arm 411 of the second signal terminal S2 are both partially insert-molded with the first retaining block 47.

Specifically, in the illustrated embodiment of the present disclosure, the first retaining block 47 includes a first base portion 471, a first support portion 472 extending from one end of the first base portion 471, and a first covering portion 473 extending from another end of the first base portion 471. The first contact elastic arm 411 of the first signal terminal S1 and the first contact elastic arm 411 of the second signal terminal S2 are at least partially fixed to the first base portion 471. The first contact elastic arm 411 of the first signal terminal S1 and the first contact elastic arm 411 of the second signal terminal S2 are at least partially exposed to and supported by the first support portion 472. The second inclined portion 414 of the first signal terminal S1 and the second inclined portion 414 of the second signal terminal S2 are at least partially fixed to the first covering portion 473.

In the illustrated embodiment of the present disclosure, the first retaining block 47 includes a first positioning block 474 and a second positioning block 475 which extend from the first support portion 472 respectively along the third direction A3-A3. The first contact elastic arm 411 of the first signal terminal S1 and the first contact elastic arm 411 of the second signal terminal S2 are restricted between the first positioning block 474 and the second positioning block 475. The first positioning block 474 abuts against the first contact elastic arm 411 of the first signal terminal S1 to restrict the first contact elastic arm 411 of the first signal terminal S1. The second positioning block 475 abuts against the first contact elastic arm 411 of the second signal terminal S2 to restrict the first contact elastic arm 411 of the second signal terminal S2.

In the illustrated embodiment of the present disclosure, the first connecting portion 412 of the first ground terminal G1 and the first connecting portion 412 of the second ground terminal G2 each include a first fixing portion 4121 and at least one first protruding portion 4122 protruding beyond the first fixing portion 4121. The first fixing portion 4121 of the first conductive terminal 41 is fixed to the first body portion 401 of the first insulating block 40. In the illustrated embodiment of the present disclosure, the first fixing portion 4121 of the first ground terminal G1 includes a first fixing tab 4121a fixed in the first insulating block 40. The first fixing portion 4121 of the second ground terminal G2 includes a second fixing tab 4121b fixed in the first insulating block 40.

Besides, the first inclined portion 413 of the first ground terminal G1 and the first inclined portion 413 of the second ground terminal G3 each include a second fixing portion 4131 and at least one first protrusion 4132 protruding beyond the second fixing portion 4131. The second fixing portion 4131 of the first conductive terminal 41 is fixed to the first inclined wall 402 of the first insulating block 40. In the illustrated embodiment of the present disclosure, the second fixing portion 4131 of the first ground terminal G1 includes a third fixing tab 4131a fixed in the first insulating block 40. The second fixing portion 4131 of the second ground terminal G2 includes a fourth fixing tab 4131b fixed in the first insulating block 40.

The first shielding plate 43 is made of metal material, and includes a first base plate portion 431 shielded on the first connecting portion 412, a first shielding portion 432 shielded on the first inclined portion 413, a first extending portion 433 and a second extending portion 434 connected to the first base plate portion 431, and a first beam 435 connecting the first extending portion 433 and the second extending portion 434. The first extending portion 433 and the second extending portion 434 both extend beyond the first beam 435. The first shielding plate 43 is neither in contact with the first signal terminal S1 nor the second signal terminal S2 in order to avoid short circuit. The first base plate portion 431 defines at least one first mounting hole 4311 to mate with the first protruding portion 4122. The first shielding portion 432 defines at least one first fixing hole 4321 to mate with the first protrusion 4132. The first extending portion 433 is in contact with the second inclined portion 414 of the first ground terminal G1. The second extending portion 434 is in contact with the second inclined portion 414 of the second ground terminal G2.

The first shielding plate 43 of the present disclosure generally extends along the second inclined portion 414, the first connecting portion 412 and the first inclined portion 413 of the first conductive terminal 41, therefore, these portions of the first conductive terminal 41 can be better shielded. In addition, by providing the first protruding portion 4122 and the first protrusion 4132, and passing them through the first shielding plate 43, it is possible to avoid leaving openings on the first shielding plate 43 that affect the shielding performance, thereby being beneficial to improving the quality of signal transmission.

The first tail portions 415 are configured to be mounted on the circuit board 300. For example, the first tail portions 415 are fixed to the first conductive pads 301 of the circuit board 300 by soldering or welding. A dimension of the first tail portion 415 of the first ground terminal G1 along the third direction A3-A3 is larger than a dimension of the first tail portion 415 of the first signal terminal S1 along the third direction A3-A3. The dimension of the first tail portion 415 of the first ground terminal G1 along the third direction A3-A3 is larger than a dimension of the first tail portion 415 of the second signal terminal S2 along the third direction A3-A3. A dimension of the first tail portion 415 of the second ground terminal G2 along the third direction A3-A3 is larger than the dimension of the first tail portion 415 of the first signal terminal S1 along the third direction A3-A3. The dimension of the first tail portion 415 of the second ground terminal G2 along the third direction A3-A3 is larger than the dimension of the first tail portion 415 of the second signal terminal S2 along the third direction A3-A3. With this arrangement, the relatively high-height first tail portion 415 of the first ground terminal G1 and the relatively high-height first tail portion 415 of the second ground terminal G2 are provided on two sides of the first tail portion 415 of the first signal terminal S1 and the first tail portion 415 of the second signal terminal S2, respectively, in the length direction, which is beneficial to further improving the quality of signal transmission.

The first ground piece 45 is fixed on the first retaining block 47. The first ground piece 45 defines a first opening 451 that is locked with the first retaining block 47. The first ground piece 45 is in contact with the first ground terminal G1 and the second ground terminal G2.

The plurality of second conductive terminals 42 include a third signal terminal S3, a fourth signal terminal S4, a third ground terminal G3 disposed on one side of the third signal terminal S3 and the fourth signal terminal S4, and a fourth ground terminal G4 disposed on another side of the third signal terminal S3 and the fourth signal terminal S4. The third ground terminal G3, the third signal terminal S3, the fourth signal terminal S4 and the fourth ground terminal G4 are disposed in sequence along the second direction A2-A2. In an embodiment of the present disclosure, the third signal terminal S3 and the fourth signal terminal S4 form a second differential pair DP2 in order to increase the signal transmission rate.

Each second conductive terminal 42 includes a second contact elastic arm 421, a second connecting portion 422 connected to the second contact elastic arm 421, a third inclined portion 423 connected to the second connecting portion 422, and a second tail portion 425 extending from the third inclined portion 423. The second contact elastic arm 421 is provided with a second arc-shaped end portion 4211. The second arc-shaped end portion 4211 includes a second contact portion 4211a that protrudes into the receiving slot 110 and is configured to contact the mating module 200 for achieving electrical connection.

In the illustrated embodiment of the present disclosure, a dimension of the second arc-shaped end portion 4211 of the third ground terminal G3 along the third direction A3-A3 is larger than a dimension of the second arc-shaped end portion 4211 of the third signal terminal S3 along the third direction A3-A3. The dimension of the second arc-shaped end portion 4211 of the third ground terminal G3 along the third direction A3-A3 is larger than a dimension of the second arc-shaped end portion 4211 of the fourth signal terminal S4 along the third direction A3-A3. A dimension of the second arc-shaped end portion 4211 of the fourth ground terminal G4 along the third direction A3-A3 is larger than the dimension of the second arc-shaped end portion 4211 of the third signal terminal S3 along the third direction A3-A3. The dimension of the second arc-shaped end portion 4211 of the fourth ground terminal G4 along the third direction A3-A3 is larger than the dimension of the second arc-shaped end portion 4211 of the fourth signal terminal S4 along the third direction A3-A3. With this arrangement, the relatively high-height second arc-shaped end portion 4211 of the ground terminal G3 and the relatively high-height second arc-shaped end portion 4211 of the fourth ground terminal G4 are respectively provided on two sides of the second arc-shaped end portion 4211 of the third signal terminal S3 and the second arc-shaped end portion 4211 of the fourth signal terminal S4, which is beneficial to improving the quality of signal transmission.

In the illustrated embodiment of the present disclosure, a dimension of the second contact elastic arm 421 of the third ground terminal G3 along the third direction A3-A3 is larger than a dimension of the second contact elastic arm 421 of the third signal terminal S3 along the third direction A3-A3. The dimension of the second contact elastic arm 421 of the third ground terminal G3 along the third direction A3-A3 is larger than a dimension of the second contact elastic arm 421 of the fourth signal terminal S4 along the third direction A3-A3. A dimension of the second contact elastic arm 421 of the fourth ground terminal G4 along the third direction A3-A3 is larger than the dimension of the second contact elastic arm 421 of the third signal terminal S3 along the third direction A3-A3. The dimension of the second contact elastic arm 421 of the fourth ground terminal G4 along the third direction A3-A3 is larger than the dimension of the second contact elastic arm 421 of the fourth signal terminal S4 along the third direction A3-A3. With this arrangement, the relatively high-height second contact elastic arm 421 of the third ground terminal G3 and the relatively high-height second contact elastic arm 421 of the fourth ground terminal G4 are respectively provided on two sides of the second contact elastic arm 421 of the third signal terminal S3 and the second contact elastic arm 421 of the fourth signal terminal S4 in the length direction, which is conducive to further improving the quality of signal transmission.

In the illustrated embodiment of the present disclosure, the third ground terminal G3 and the fourth ground terminal G4 are both made by blanking. It is understandable to those skilled in the art that the so-called “by blanking” means that a terminal width of the third ground terminal G3 and the fourth ground terminal G4 along the second direction A2-A2 is the same as a width of a material strip. In other words, if the terminal widths of the third ground terminal G3 and the fourth ground terminal G4 along the second direction A2-A2 need to be larger, correspondingly, a thicker material strip needs to be used.

The third signal terminal S3 and the fourth signal terminal S4 are both made by stamping. It is understandable to those skilled in the art that the so-called “by stamping” means that the third signal terminal S3 and the fourth signal terminal S4 are stamped from a metal plate. The widths of the third signal terminal S3 and the fourth signal terminal S4 can be stamped and formed on the metal plate as needed. The width of the third signal terminal S3 and the fourth signal terminal S4 is not affected by the thickness of the metal plate.

Of course, it is understandable to those skilled in the art that the second contact elastic arm 421 of the third ground terminal G3 and the second contact elastic arm 421 of the fourth ground terminal G4 which are made by blanking have greater rigidity compared to the second contact elastic arm 421 of the third signal terminal S3 and the second contact elastic arm 421 of the fourth signal terminal S4 which are made by stamping. In other words, the second contact elastic arms 421 of the third ground terminal G3 and the fourth ground terminal G4 made by blanking are not prone to elastic deformation compared to the second contact elastic arms 421 of the third signal terminal S3 and the fourth signal terminal S4 made by stamping.

In the illustrated embodiment of the present disclosure, the second contact portion 4211a of the third signal terminal S3 is flush with the second contact portion 4211a of the fourth signal terminal S4. The second contact portion 4211a of the third ground terminal G3 is flush with the second contact portion 4211a of the fourth ground terminal G4.

The second contact portion 4211a of the third signal terminal S3 and the second contact portion 4211a of the fourth signal terminal S4 protrude downwardly beyond the second contact portion 4211a of the third ground terminal G3 and the second contact portion 4211a of the fourth ground terminal G4 along the third direction A3-A3, so that the second contact portion 4211a of the third signal terminal S3 and the second contact portion 4211a of the fourth signal terminal S4 protrude into the receiving slot 110 further than the second contact portion 4211a of the third ground terminal G3 and the second contact portion 4211a of the fourth ground terminal G4. With this arrangement, by placing the second contact portion 4211a of the third ground terminal G3 and the second contact portion 4211a of the fourth ground terminal G4 that are less likely to elastically deform, further away from the receiving slot 110, it is possible to form a balance between the third ground terminal G3 and the fourth ground terminal G4 made by blanking, and the third signal terminal S3 and the fourth signal terminal S4 made by stamping.

In the illustrated embodiment of the present disclosure, the first terminal module M1 further includes a second retaining block 48 fixed on the third signal terminal S3 and the fourth signal terminal S4, so that the third signal terminal S3, the fourth signal terminal S4 and the second retaining block 48 are formed into an integrated second terminal module TM2. In one embodiment of the present disclosure, the second contact elastic arm 421 of the third signal terminal S3 and the second contact elastic arm 421 of the fourth signal terminal S4 are both partially insert-molded with the second retaining block 48.

Specifically, in the illustrated embodiment of the present disclosure, the second retaining block 48 includes a second base portion 481 and a second support portion 482 extending from the second base portion 481. The second contact elastic arm 421 of the third signal terminal S3 and the second contact elastic arm 421 of the fourth signal terminal S4 are at least partially fixed to the second base portion 481. The second contact elastic arm 421 of the third signal terminal S3 and the second contact elastic arm 421 of the fourth signal terminal S4 are at least partially exposed to and supported by the second support portion 482.

In the illustrated embodiment of the present disclosure, the second connecting portion 422 of the third ground terminal G3 and the second connecting portion 422 of the fourth ground terminal G4 each include a fifth fixing tab 422a. The second connecting portion 422 of the second conductive terminal 42 is fixed to the first body portion 401 of the first insulating block 40. The third ground terminal G3 and the fourth ground terminal G4 further include a sixth fixing tab 423a extending from the second tail portion 425 and fixed in the first insulating block 40.

Besides, the third inclined portion 423 of the third ground terminal G3 and the third inclined portion 423 of the fourth ground terminal G4 each include a third fixing portion 4231 and at least one second protrusion 4232 protruding beyond the third fixing portion 4231. The third fixing portion 4231 of the second conductive terminal 42 is fixed to the second inclined wall 403 of the first insulating block 40.

The second shielding plate 44 is made of metal material and includes a second base plate portion 441 shielded on the third inclined portion 423. The second shielding plate 44 is neither in contact with the third signal terminal S3 nor the fourth signal terminal S4 in order to avoid short circuit. The second base plate portion 441 defines at least one second mounting hole 4411 to mate with the second protrusion 4232.

The second tail portions 425 are configured to be mounted on the circuit board 300. For example, the second tail portions 425 are fixed to the second conductive pads 302 of the circuit board 300 by soldering or welding. A dimension of the second tail portion 425 of the third ground terminal G3 along the third direction A3-A3 is larger than a dimension of the second tail portion 425 of the third signal terminal S3 along the third direction A3-A3. The dimension of the second tail portion 425 of the third ground terminal G3 along the third direction A3-A3 is larger than a dimension of the second tail portion 425 of the fourth signal terminal S4 along the third direction A3-A3. A dimension of the second tail portion 425 of the fourth ground terminal G4 along the third direction A3-A3 is larger than the dimension of the second tail portion 425 of the third signal terminal S3 along the third direction A3-A3. The dimension of the second tail portion 425 of the fourth ground terminal G4 along the third direction A3-A3 is larger than the dimension of the second tail portion 425 of the fourth signal terminal S4 along the third direction A3-A3. With this arrangement, the relatively high-height second tail portion 425 of the third ground terminal G3 and the relatively high-height second tail portion 425 of the fourth ground terminal G4 are provided on two sides of the second tail portion 425 of the third signal terminal S3 and the second tail portion 425 of the fourth signal terminal S4, respectively, in the length direction, which is beneficial to further improving the quality of signal transmission.

The second ground piece 46 is fixed on the second retaining block 48. The second ground piece 46 defines a second opening 461 that is locked with the second retaining block 48. The second ground piece 46 is in contact with the third ground terminal G3 and the fourth ground terminal G4.

In the illustrated embodiment of the present disclosure, the second terminal module M2 includes a second insulating block 50, a plurality of third conductive terminals 51, a plurality of fourth conductive terminals 52, a third shielding plate 53, a fourth shielding plate 54, a third ground piece 55 and a fourth ground piece 56.

The plurality of third conductive terminals 51 include a fifth signal terminal S5, a sixth signal terminal S6, a fifth ground terminal G5 disposed on one side of the fifth signal terminal S5 and the sixth signal terminal S6, and a sixth ground terminal G6 disposed on another side of the fifth signal terminal S5 and the sixth signal terminal S6. The fifth ground terminal G5, the fifth signal terminal S5, the sixth signal terminal S6 and the sixth ground terminal G6 are disposed in sequence along the second direction A2-A2. In an embodiment of the present disclosure, the fifth signal terminal S5 and the sixth signal terminal S6 form a third differential pair DP3 in order to increase the signal transmission rate.

Each third conductive terminal 51 includes a third contact elastic arm 511, a third connecting portion 512, a fourth inclined portion 514 connected between the third contact elastic arm 511 and the third connecting portion 512, and a third tail portion 515. The third contact elastic arm 511 is provided with a third arc-shaped end portion 5111. The third arc-shaped end portion 5111 includes a third contact portion 5111a that protrudes into the receiving slot 110 and is configured to contact the mating module 200 for achieving electrical connection.

In the illustrated embodiment of the present disclosure, a dimension of the third arc-shaped end portion 5111 of the fifth ground terminal G5 along the third direction A3-A3 is larger than a dimension of the third arc-shaped end portion 5111 of the fifth signal terminal S5 along the third direction A3-A3. The dimension of the third arc-shaped end portion 5111 of the fifth ground terminal G5 along the third direction A3-A3 is larger than a dimension of the third arc-shaped end portion 5111 of the sixth signal terminal S6 along the third direction A3-A3. A dimension of the third arc-shaped end portion 5111 of the sixth ground terminal G6 along the third direction A3-A3 is larger than the dimension of the third arc-shaped end portion 5111 of the fifth signal terminal S5 along the third direction A3-A3. The dimension of the third arc-shaped end portion 5111 of the sixth ground terminal G6 along the third direction A3-A3 is larger than the dimension of the third arc-shaped end portion 5111 of the sixth signal terminal S6 along the third direction A3-A3. With this arrangement, the relatively high-height third arc-shaped end portion 5111 of the fifth ground terminal G5 and the relatively high-height third arc-shaped end portion 5111 of the sixth ground terminal G6 are provided on two sides of the third arc-shaped end portion 5111 of the fifth signal terminal S5 and the third arc-shaped end portion 5111 of the sixth signal terminal S6, respectively, which is beneficial to improving the quality of signal transmission.

In the illustrated embodiment of the present disclosure, a dimension of the third contact elastic arm 511 of the fifth ground terminal G5 along the third direction A3-A3 is larger than a dimension of the third contact elastic arm 511 of the fifth signal terminal S5 along the third direction A3-A3. The dimension of the third contact elastic arm 511 of the fifth ground terminal G5 along the third direction A3-A3 is larger than a dimension of the third contact elastic arm 511 of the sixth signal terminal S6 along the third direction A3-A3. A dimension of the third contact elastic arm 511 of the sixth ground terminal G6 along the third direction A3-A3 is larger than the dimension of the third contact elastic arm 511 of the fifth signal terminal S5 along the third direction A3-A3. The dimension of the third contact elastic arm 511 of the sixth ground terminal G6 along the third direction A3-A3 is larger than the dimension of the third contact elastic arm 511 of the sixth signal terminal S6 along the third direction A3-A3. With this arrangement, the relatively high-height third contact elastic arm 511 of the fifth ground terminal G5 and the relatively high-height third contact elastic arm 511 of the sixth ground terminal G6 are provided on two sides of the third contact elastic arm 511 of the fifth signal terminal S5 and the third contact elastic arm 511 of the sixth signal terminal S6, respectively, in the length direction, which is beneficial to further improving the quality of signal transmission.

In the illustrated embodiment of the present disclosure, the fifth ground terminal G5 and the sixth ground terminal G6 are both made by blanking. It is understandable to those skilled in the art that the so-called “by blanking” means that a terminal width of the fifth ground terminal G5 and the sixth ground terminal G6 along the second direction A2-A2 is the same as a width of a material strip. In other words, if the terminal widths of the fifth ground terminal G5 and the sixth ground terminal G6 along the second direction A2-A2 need to be larger, correspondingly, a thicker material strip needs to be used.

The fifth signal terminal S5 and the sixth signal terminal S6 are both made by stamping. It is understandable to those skilled in the art that the so-called “by stamping” means that the fifth signal terminal S5 and the sixth signal terminal S6 are stamped from a metal plate. The widths of the fifth signal terminal S5 and the sixth signal terminal S6 can be stamped and formed on the metal plate as needed. The width of the fifth signal terminal S5 and the sixth signal terminal S6 is not affected by the thickness of the metal plate.

Of course, it is understandable to those skilled in the art that the third contact elastic arm 511 of the fifth ground terminal G5 and the third contact elastic arm 511 of the sixth ground terminal G6 which are made by blanking have greater rigidity compared to the third contact elastic arm 511 of the fifth signal terminal S5 and the third contact elastic arm 511 of the sixth signal terminal S6 which are made by stamping. In other words, the third contact elastic arms 511 of the fifth ground terminal G5 and the sixth ground terminal G6 made by blanking are not prone to elastic deformation compared to the third contact elastic arms 511 of the fifth signal terminal S5 and the sixth signal terminal S6 made by stamping.

In the illustrated embodiment of the present disclosure, the third contact portion 5111a of the fifth signal terminal S5 is flush with the third contact portion 5111a of the sixth signal terminal S6. The third contact portion 5111a of the fifth ground terminal G5 is flush with the third contact portion 5111a of the sixth ground terminal G6.

The third contact portion 5111a of the fifth signal terminal S5 and the third contact portion 5111a of the sixth signal terminal S6 protrude upwardly beyond the third contact portion 5111a of the fifth ground terminal G5 and the third contact portion 5111a of the sixth ground terminal G6 along the third direction A3-A3, so that the third contact portion 5111a of the fifth signal terminal S5 and the third contact portion 5111a of the sixth signal terminal S6 protrude into the receiving slot 110 further than the third contact portion 5111a of the fifth ground terminal G5 and the third contact portion 5111a of the sixth ground terminal G6. With this arrangement, by locating the third contact portion 5111a of the fifth ground terminal G5 and the third contact portion 5111a of the sixth ground terminal G6 that are less likely to elastically deform, further away from the receiving slot 110, it is possible to form a balance between the fifth ground terminal G5 and the sixth ground terminal G6 made by blanking, and the fifth signal terminal S5 and the sixth signal terminal S6 made by stamping.

In the illustrated embodiment of the present disclosure, the second terminal module M2 further includes a third retaining block 57 fixed on the fifth signal terminal S5 and the sixth signal terminal S6, so that the fifth signal terminal S5, the sixth signal terminal S6 and the third retaining block 57 form an integrated third terminal module TM3. In one embodiment of the present disclosure, the third contact elastic arm 511 of the fifth signal terminal S5 and the third contact elastic arm 511 of the sixth signal terminal S6 are both partially insert-molded in the third retaining block 57.

Specifically, in the illustrated embodiment of the present disclosure, the third retaining block 57 includes a third base portion 571 and a third support portion 572 extending from one end of the third base portion 571. The third contact elastic arm 511 of the fifth signal terminal S5 and the third contact elastic arm 511 of the sixth signal terminal S6 are at least partially fixed to the third base portion 571. The third contact elastic arm 511 of the fifth signal terminal S5 and the third contact elastic arm 511 of the sixth signal terminal S6 are at least partially exposed to and supported by the third support portion 572.

In the illustrated embodiment of the present disclosure, the third connecting portion 512 of the fifth ground terminal G5 and the third connecting portion 512 of the sixth ground terminal G6 each include a fourth fixing portion 5121 and at least one third protruding portion 5122 protruding beyond the fourth fixing portion 5121. The fourth fixing portion 5121 of the third conductive terminal 51 is fixed to the second insulating block 50.

The third shielding plate 53 is made of metal material and includes a third base plate portion 531 shielded on the third connecting portion 512, a third extending portion 533 and a fourth extending portion 534 connected to the third base plate portion 531, and a second beam 535 connecting the third extending portion 533 and the fourth extending portion 534. The third extending portion 533 and the fourth extending portion 534 both extend beyond the second beam 535. The third shielding plate 53 is neither in contact with the fifth signal terminal S5 nor the sixth signal terminal S6 in order to avoid short circuit. The third base plate portion 531 defines at least one third mounting hole 5311 to mate with the third protruding portion 5122.

The third tail portions 515 are configured to be mounted on the circuit board 300. For example, the third tail portions 515 are fixed to the third conductive pads 303 of the circuit board 300 by soldering or welding. A dimension of the third tail portion 515 of the fifth ground terminal G5 along the third direction A3-A3 is larger than a dimension of the third tail portion 515 of the fifth signal terminal S5 along the third direction A3-A3. The dimension of the third tail portion 515 of the fifth ground terminal G5 along the third direction A3-A3 is larger than a dimension of the third tail portion 515 of the sixth signal terminal S6 along the third direction A3-A3. A dimension of the third tail portion 515 of the sixth ground terminal G6 along the third direction A3-A3 is larger than the dimension of the third tail portion 515 of the fifth signal terminal S5 along the third direction A3-A3. The dimension of the third tail portion 515 of the sixth ground terminal G6 along the third direction A3-A3 is larger than the dimension of the third tail portion 515 of the sixth signal terminal S6 along the third direction A3-A3. With this arrangement, the relatively high-height third tail portion 515 of the fifth ground terminal G5 and the relatively high-height third tail portion 515 of the sixth ground terminal G6 are provided on two sides of the third tail portion 515 of the fifth signal terminal S5 and the third tail portion 515 of the sixth signal terminal S6, respectively, in the length direction, which is beneficial to further improving the quality of signal transmission.

The third ground piece 55 is fixed on the third retaining block 57. The third ground piece 55 defines a third opening 551 that is locked with the third retaining block 57. The third ground piece 55 is in contact with the fifth ground terminal G5 and the sixth ground terminal G6.

The plurality of fourth conductive terminals 52 include a seventh signal terminal S7, an eighth signal terminal S8, a seventh ground terminal G7 disposed on one side of the seventh signal terminal S7 and the eighth signal terminal S8, and an eighth ground terminal G8 disposed on another side of the seventh signal terminal S7 and the eighth signal terminal S8. The seventh ground terminal G7, the seventh signal terminal S7, the eighth signal terminal S8 and the eighth ground terminal G8 are disposed in sequence along the second direction A2-A2. In an embodiment of the present disclosure, the seventh signal terminal S7 and the eighth signal terminal S8 form a fourth differential pair DP4 in order to increase the signal transmission rate.

Each fourth conductive terminal 52 includes a fourth contact elastic arm 521, a fourth connecting portion 522 connected to the fourth contact elastic arm 521, and a fourth tail portion 525. The fourth connecting portion 522 is generally L-shaped. The fourth contact elastic arm 521 is provided with a fourth arc-shaped end portion 5211. The fourth arc-shaped end portion 5211 includes a fourth contact portion 5211a that protrudes into the receiving slot 110 and is configured to contact the mating module 200 for achieving electrical connection.

In the illustrated embodiment of the present disclosure, a dimension of the fourth arc-shaped end portion 5211 of the seventh ground terminal G7 along the third direction A3-A3 is larger than a dimension of the fourth arc-shaped end portion 5211 of the seventh signal terminal S7 along the third direction A3-A3. The dimension of the fourth arc-shaped end portion 5211 of the seventh ground terminal G7 along the third direction A3-A3 is larger than a dimension of the fourth arc-shaped end portion 5211 of the eighth signal terminal S8 along the third direction A3-A3. A dimension of the fourth arc-shaped end portion 5211 of the eighth ground terminal G8 along the third direction A3-A3 is larger than the dimension of the fourth arc-shaped end portion 5211 of the seventh signal terminal S7 along the third direction A3-A3. The dimension of the fourth arc-shaped end portion 5211 of the eighth ground terminal G8 along the third direction A3-A3 is larger than a dimension of the fourth arc-shaped end portion 5211 of the eighth signal terminal S8 along the third direction A3-A3. With this arrangement, the relatively high-height fourth arc-shaped end portion 5211 of the seventh ground terminal G7 and the relatively high-height fourth arc-shaped end portion 5211 of the eighth ground terminal G8 are provided on two sides of the fourth arc-shaped end portion 5211 of the seventh signal terminal S7 and the fourth arc-shaped end portion 5211 of the eighth signal terminal S8, respectively, which is beneficial to improving the quality of signal transmission.

In the illustrated embodiment of the present disclosure, a dimension of the fourth contact elastic arm 521 of the seventh ground terminal G7 along the third direction A3-A3 is larger than a dimension of the fourth contact elastic arm 521 of the seventh signal terminal S7 along the third direction A3-A3. The dimension of the fourth contact elastic arm 521 of the seventh ground terminal G7 along the third direction A3-A3 is larger than a dimension of the fourth contact elastic arm 521 of the eighth signal terminal S8 along the third direction A3-A3. A dimension of the fourth contact elastic arm 521 of the eighth ground terminal G8 along the third direction A3-A3 is larger than the dimension of the fourth contact elastic arm 521 of the seventh signal terminal S7 along the third direction A3-A3. The dimension of the fourth contact elastic arm 521 of the eighth ground terminal G8 along the third direction A3-A3 is larger than the dimension of the fourth contact elastic arm 521 of the eighth signal terminal S8 along the third direction A3-A3. With this arrangement, the relatively high-height fourth contact elastic arm 521 of the seventh ground terminal G7 and the relatively high-height fourth contact elastic arm 521 of the eighth ground terminal G8 are provided on two sides of the fourth contact elastic arm 521 of the seventh signal terminal S7 and the fourth contact elastic arm 521 of the eighth signal terminal S8, respectively, in the length direction, which is beneficial to further improving the quality of signal transmission.

In the illustrated embodiment of the present disclosure, the seventh ground terminal G7 and the eighth ground terminal G8 are both made by blanking. It is understandable to those skilled in the art that the so-called “by blanking” means that a terminal width of the seventh ground terminal G7 and the eighth ground terminal G8 along the second direction A2-A2 is the same as a width of a material strip. In other words, if the terminal widths of the seventh ground terminal G7 and the eighth ground terminal G8 along the second direction A2-A2 need to be larger, correspondingly, a thicker material strip needs to be used.

The seventh signal terminal S7 and the eighth signal terminal S8 are both made by stamping. It is understandable to those skilled in the art that the so-called “by stamping” means that the seventh signal terminal S7 and the eighth signal terminal S8 are stamped from a metal plate. The widths of the seventh signal terminal S7 and the eighth signal terminal S8 can be stamped and formed on the metal plate as needed. The width of the seventh signal terminal S7 and the eighth signal terminal S8 is not affected by the thickness of the metal plate.

Of course, it is understandable to those skilled in the art that the fourth contact elastic arm 521 of the seventh ground terminal G7 and the fourth contact elastic arm 521 of the eighth ground terminal G8 which are made by blanking have greater rigidity compared to the fourth contact elastic arm 521 of the seventh signal terminal S7 and the fourth contact elastic arm 521 of the eighth signal terminal S8 which are made by stamping. In other words, the fourth contact elastic arms 521 of the seventh ground terminal G7 and the eighth ground terminal G8 made by blanking are not prone to elastic deformation compared to the fourth contact elastic arms 521 of the seventh signal terminal S7 and the eighth signal terminal S8 made by stamping.

In the illustrated embodiment of the present disclosure, the fourth contact portion 5211a of the seventh signal terminal S7 is flush with the fourth contact portion 5211a of the eighth signal terminal S8. The fourth contact portion 5211a of the seventh ground terminal G7 is flush with the fourth contact portion 5211a of the eighth ground terminal G8.

The fourth contact portion 5211a of the seventh signal terminal S7 and the fourth contact portion 5211a of the eighth signal terminal S8 protrude upwardly beyond the fourth contact portion 5211a of the seventh ground terminal G7 and the fourth contact portion 5211a of the eighth ground terminal G8 along the third direction A3-A3, so that the fourth contact portion 5211a of the seventh signal terminal S7 and the fourth contact portion 5211a of the eighth signal terminal S8 protrude into the receiving slot 110 further than the fourth contact portion 5211a of the seventh ground terminal G7 and the fourth contact portion 5211a of the eighth ground terminal G8. With this arrangement, by placing the fourth contact portion 5211a of the seventh ground terminal G7 and the fourth contact portion 5211a of the eighth ground terminal G8 that are less likely to elastically deform, further away from the receiving slot 110, it is possible to form a balance between the seventh ground terminal G7 and the eighth ground terminal G8 made by blanking, and the seventh signal terminal S7 and the eighth signal terminal S8 made by stamping.

In the illustrated embodiment of the present disclosure, the second terminal module M2 further includes a fourth retaining block 58 fixed on the seventh signal terminal S7 and the eighth signal terminal S8, so that the seventh signal terminal S7, the eighth signal terminal S8 and the fourth retaining block 58 form an integrated fourth terminal module TM4. In one embodiment of the present disclosure, the fourth contact elastic arm 521 of the seventh signal terminal S7 and the fourth contact elastic arm 521 of the eighth signal terminal S8 are both partially insert-molded with the fourth retaining block 58.

Specifically, in the illustrated embodiment of the present disclosure, the fourth retaining block 58 includes a fourth base portion 581 and a fourth support portion 582 extending from the fourth base portion 581. The fourth contact elastic arm 521 of the seventh signal terminal S7 and the fourth contact elastic arm 521 of the eighth signal terminal S8 are at least partially fixed to the fourth base portion 581. The fourth contact elastic arm 521 of the seventh signal terminal S7 and the fourth contact elastic arm 521 of the eighth signal terminal S8 are at least partially exposed to and supported by the fourth support portion 582.

Besides, the fourth connecting portion 522 of the seventh ground terminal G7 and the fourth connecting portion 522 of the eighth ground terminal G8 each include at least one fourth protrusion 5221.

The fourth shielding plate 54 is made of metal material and includes a fourth base plate portion 541 shielded on the fourth connecting portion 522. The fourth shielding plate 54 is neither in contact with the seventh signal terminal S7 nor the eighth signal terminal S8 in order to avoid short circuit. The fourth base plate portion 541 defines at least one fourth mounting hole 5411 to mate with the fourth protrusion 5221.

The fourth tail portions 525 are configured to be mounted on the circuit board 300. For example, the fourth tail portions 525 are fixed to the fourth conductive pads 304 of the circuit board 300 by soldering or welding. A dimension of the fourth tail portion 525 of the seventh ground terminal G7 along the third direction A3-A3 is larger than a dimension of the fourth tail portion 525 of the seventh signal terminal S7 along the third direction A3-A3. The dimension of the fourth tail portion 525 of the seventh ground terminal G7 along the third direction A3-A3 is larger than a dimension of the fourth tail portion 525 of the eighth signal terminal S8 along the third direction A3-A3. A dimension of the fourth tail portion 525 of the eighth ground terminal G8 along the third direction A3-A3 is larger than the dimension of the fourth tail portion 525 of the seventh signal terminal S7 along the third direction A3-A3. The dimension of the fourth tail portion 525 of the eighth ground terminal G8 along the third direction A3-A3 is larger than the dimension of the fourth tail portion 525 of the eighth signal terminal S8 along the third direction A3-A3. With this arrangement, the relatively high-height fourth tail portion 525 of the seventh ground terminal G7 and the relatively high-height fourth tail portion 525 of the eighth ground terminal G8 are provided on two sides of the fourth tail portion 525 of the seventh signal terminal S7 and the fourth tail portion 525 of the eighth signal terminal S8, respectively, in the length direction, which is beneficial to further improving the quality of signal transmission.

The fourth ground piece 56 is fixed on the fourth retaining block 58. The fourth ground piece 56 defines a fourth opening 561 that is locked with the fourth retaining block 58. The fourth ground piece 56 is in contact with the seventh ground terminal G7 and the eighth ground terminal G8.

The first contact portions 4111a of the first conductive terminals 41 are disposed in a first row L1 along the second direction A2-A2. The second contact portions 4211a of the second conductive terminals 42 are disposed in a second row L2 along the second direction A2-A2. The first row L1 and the second row L2 are spaced apart along the first direction A1-A1. Similarly, the third contact portions 5111a of the third conductive terminals 51 are disposed in the first row L1 along the second direction A2-A2. The fourth contact portions 5211a of the fourth conductive terminals 52 are disposed in the second row L2 along the second direction A2-A2. The first row L1 and the second row L2 are spaced apart along the first direction A1-A1.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
a mounting housing, the mounting housing defining a receiving slot extending along a first direction, the receiving slot being configured to receive a mating module; and
a first terminal module, the first terminal module being directly or indirectly mounted to the mounting housing; the first terminal module comprising a plurality of first conductive terminals; the plurality of first conductive terminals comprising a first signal terminal, a second signal terminal, a first ground terminal disposed on one side of the first signal terminal and the second signal terminal, and a second ground terminal disposed on another side of the first signal terminal and the second signal terminal; the first ground terminal, the first signal terminal, the second signal terminal and the second ground terminal being disposed in sequence along a second direction; each first conductive terminal comprising a first contact elastic arm; the first contact elastic arm being provided with a first arc-shaped end portion; the first arc-shaped end portion comprising a first contact portion that protrudes into the receiving slot and is configured to contact the mating module;
wherein a dimension of the first arc-shaped end portion of the first ground terminal along a third direction is larger than a dimension of the first arc-shaped end portion of the first signal terminal along the third direction; the dimension of the first arc-shaped end portion of the first ground terminal along the third direction is larger than a dimension of the first arc-shaped end portion of the second signal terminal along the third direction; a dimension of the first arc-shaped end portion of the second ground terminal along the third direction is larger than the dimension of the first arc-shaped end portion of the first signal terminal along the third direction; the dimension of the first arc-shaped end portion of the second ground terminal along the third direction is larger than the dimension of the first arc-shaped end portion of the second signal terminal along the third direction; each two of the first direction, the second direction and the third direction are perpendicular to each other.

2. The electrical connector according to claim 1, wherein a dimension of the first contact elastic arm of the first ground terminal along the third direction is larger than a dimension of the first contact elastic arm of the first signal terminal along the third direction; the dimension of the first contact elastic arm of the first ground terminal along the third direction is larger than a dimension of the first contact elastic arm of the second signal terminal along the third direction; a dimension of the first contact elastic arm of the second ground terminal along the third direction is larger than the dimension of the first contact elastic arm of the first signal terminal along the third direction; and the dimension of the first contact elastic arm of the second ground terminal along the third direction is larger than the dimension of the first contact elastic arm of the second signal terminal along the third direction.

3. The electrical connector according to claim 1, wherein the first ground terminal and the second ground terminal are both made by blanking; the first signal terminal and the second signal terminal are both made by stamping.

4. The electrical connector according to claim 1, wherein the first contact portion of the first signal terminal is flush with the first contact portion of the second signal terminal; the first contact portion of the first ground terminal is flush with the first contact portion of the second ground terminal;
both the first contact portion of the first signal terminal and the first contact portion of the second signal terminal protrude beyond the first contact portion of the first ground terminal and the first contact portion of the second ground terminal along the third direction, so that both the first contact portion of the first signal terminal and the first contact portion of the second signal terminal protrude into the receiving slot further than the first contact portion of the first ground terminal and the first contact portion of the second ground terminal.

5. The electrical connector according to claim 1, wherein each first conductive terminal comprises a first connecting portion;
each of the first connecting portion of the first ground terminal and the first connecting portion of the second ground terminal comprises a first fixing portion and at least one first protruding portion protruding beyond the first fixing portion;
the electrical connector comprises a first shielding plate; the first shielding plate comprises a first base plate portion shielded on the first connecting portion; the first shielding plate is neither in contact with the first signal terminal nor the second signal terminal; the first base plate portion defines at least one first mounting hole to mate with the at least one first protruding portion.

6. The electrical connector according to claim 5, wherein each first conductive terminal comprises a first inclined portion connected to the first connecting portion;
each of the first inclined portion of the first ground terminal and the first inclined portion of the second ground terminal comprises a second fixing portion and at least one first protrusion protruding beyond the second fixing portion;
the first shielding plate comprises a first shielding portion shielded on the first inclined portion; the first shielding portion defines at least one first fixing hole to mate with the at least one first protrusion.

7. The electrical connector according to claim 5, wherein each first conductive terminal comprises a second inclined portion connected between the first contact elastic arm and the first connecting portion;
the first shielding plate comprises a first extending portion and a second extending portion connected to the first base plate portion; the first extending portion is in contact with the second inclined portion of the first ground terminal; the second extending portion is in contact with the second inclined portion of the second ground terminal.

8. The electrical connector according to claim 7, wherein the first shielding plate further comprises a first beam connecting the first extending portion and the second extending portion; both the first extending portion and the second extending portion extend beyond the first beam.

9. The electrical connector according to claim 1, wherein each first conductive terminal comprises a first tail portion configured to be mounted on a circuit board;
a dimension of the first tail portion of the first ground terminal along the third direction is larger than a dimension of the first tail portion of the first signal terminal along the third direction; the dimension of the first tail portion of the first ground terminal along the third direction is larger than a dimension of the first tail portion of the second signal terminal along the third direction; a dimension of the first tail portion of the second ground terminal along the third direction is larger than the dimension of the first tail portion of the first signal terminal along the third direction; the dimension of the first tail portion of the second ground terminal along the third direction is larger than the dimension of the first tail portion of the second signal terminal along the third direction.

10. The electrical connector according to claim 1, wherein the first terminal module comprises a first insulating block; the first conductive terminals is fixed to the first insulating block; the first contact elastic arm extends beyond the first insulating block;
the electrical connector further comprises a first retaining block fixed on the first contact elastic arm of the first signal terminal and the first contact elastic arm of the second signal terminal; the first retaining block comprises a first base portion and a first support portion extending from the first base portion; the first contact elastic arm of the first signal terminal and the first contact elastic arm of the second signal terminal are at least partially fixed to the first base portion; the first contact elastic arm of the first signal terminal and the first contact elastic arm of the second signal terminal are at least partially exposed to and supported by the first support portion.

11. The electrical connector according to claim 10, wherein the first retaining block comprises a first positioning block and a second positioning block which extend from the first support portion respectively along the third direction; the first contact elastic arm of the first signal terminal and the first contact elastic arm of the second signal terminal are restricted between the first positioning block and the second positioning block; the first positioning block abuts against the first contact elastic arm of the first signal terminal to restrict the first contact elastic arm of the first signal terminal; the second positioning block abuts against the first contact elastic arm of the second signal terminal to restrict the first contact elastic arm of the second signal terminal.

12. The electrical connector according to claim 11, wherein the first terminal module further comprises a first ground piece fixed on the first retaining block; the first ground piece defines a first opening that is locked with the first retaining block; the first ground piece is in contact with the first ground terminal and the second ground terminal.

13. The electrical connector according to claim 1, wherein the first terminal module comprises a first insulating block; the first conductive terminal is fixed to the first insulating block; the first contact elastic arm extends beyond the first insulating block;
the first terminal module further comprises a plurality of second conductive terminals; the plurality of second conductive terminals comprise a third signal terminal, a fourth signal terminal, a third ground terminal disposed on one side of the third signal terminal and the fourth signal terminal, and a fourth ground terminal disposed on another side of the third signal terminal and the fourth signal terminal; the third ground terminal, the third signal terminal, the fourth signal terminal and the fourth ground terminal are disposed in sequence along the second direction; each second conductive terminal comprises a second contact elastic arm; the second contact elastic arm is provided with a second arc-shaped end portion; the second arc-shaped end portion comprises a second contact portion that protrudes into the receiving slot and is configured to contact the mating module; the second conductive terminal is fixed to the first insulating block; the second contact elastic arm extends beyond the first insulating block;
the first contact portions of the first conductive terminals are disposed in a first row along the second direction; the second contact portions of the second conductive terminals are disposed in a second row along the second direction; the first row and the second row are spaced apart along the first direction.

14. The electrical connector according to claim 13, wherein the third ground terminal and the fourth ground terminal are both made by blanking; the third signal terminal and the fourth signal terminal are both made by stamping.

15. The electrical connector according to claim 13, wherein the second contact portion of the third signal terminal is flush with the second contact portion of the fourth signal terminal; the second contact portion of the third ground terminal is flush with the second contact portion of the fourth ground terminal;
the second contact portion of the third signal terminal and the second contact portion of the fourth signal terminal protrude beyond the second contact portion of the third ground terminal and the second contact portion of the fourth ground terminal along the third direction, so that the second contact portion of the third signal terminal and the second contact portion of the fourth signal terminal protrude into the receiving slot further than the second contact portion of the third ground terminal and the second contact portion of the fourth ground terminal.

16. The electrical connector according to claim 13, wherein each second conductive terminal comprises a third inclined portion;
each of the third inclined portion of the third ground terminal and the third inclined portion of the fourth ground terminal comprises a second fixing portion and at least one second protruding portion protruding beyond the second fixing portion;
the electrical connector comprises a second shielding plate; the second shielding plate comprises a second base plate portion shielded on the third inclined portion; the second shielding plate is neither in contact with the third signal terminal nor the fourth signal terminal; the second base plate portion defines at least one second mounting hole to mate with the second protruding portion.

17. The electrical connector according to claim 13, further comprising a second retaining block fixed on the second contact elastic arm of the third signal terminal and the second contact elastic arm of the fourth signal terminal; the second contact elastic arm of the third signal terminal and the second contact elastic arm of the fourth signal terminal extend beyond the second retaining block;
the first terminal module further comprises a second ground piece fixed on the second retaining block; the second ground piece defines a second opening that is held by the second retaining block; the second ground piece is in contact with the third ground terminal and the fourth ground terminal.

18. An electrical connector, comprising:
a mounting housing defining a receiving slot extending along a first direction; the receiving slot being configured to receive a mating module; and
a first terminal module comprising a plurality of first conductive terminals; the plurality of first conductive terminals comprising a first signal terminal, a second signal terminal, a first ground terminal and a second ground terminal; the first signal terminal and the second signal terminal together forming a first differential pair; the first ground terminal, the first signal terminal, the second signal terminal and the second ground terminal being disposed in sequence along a second direction; each first conductive terminal comprising a first contact elastic arm; the first contact elastic arm being provided with a first arc-shaped end portion; the first arc-shaped end portion comprising a first contact portion that protrudes into the receiving slot and is configured to electrically contact the mating module;
wherein a dimension of the first arc-shaped end portion of the first ground terminal along a third direction is larger than a dimension of the first arc-shaped end portion of the first signal terminal along the third direction; the dimension of the first arc-shaped end portion of the first ground terminal along the third direction is larger than a dimension of the first arc-shaped end portion of the second signal terminal along the third direction; a dimension of the first arc-shaped end portion of the second ground terminal along the third direction is larger than the dimension of the first arc-shaped end portion of the first signal terminal along the third direction; the dimension of the first arc-shaped end portion of the second ground terminal along the third direction is larger than the dimension of the first arc-shaped end portion of the second signal terminal along the third direction; each two of the first direction, the second direction and the third direction are perpendicular to each other.

19. The electrical connector according to claim 18, wherein the first ground terminal and the second ground terminal are both made by blanking; the first signal terminal and the second signal terminal are both made by stamping.

20. The electrical connector according to claim 18, wherein the first contact portion of the first signal terminal is flush with the first contact portion of the second signal terminal; the first contact portion of the first ground terminal is flush with the first contact portion of the second ground terminal;
both the first contact portion of the first signal terminal and the first contact portion of the second signal terminal protrude beyond the first contact portion of the first ground terminal and the first contact portion of the second ground terminal along the third direction, so that both the first contact portion of the first signal terminal and the first contact portion of the second signal terminal protrude into the receiving slot further than the first contact portion of the first ground terminal and the first contact portion of the second ground terminal.
